(19) United States
(12) Patent Application Publication
(10) Pub. No.: US 2018/0273311 A1
(43) Pub. Date: Sep. 27, 2018

(54) ACOUSTIC SEPARATING APPARATUS

(71) Applicant: ZBV-AUTOMATION GMBH, Troisdorf (DE)

(72) Inventors: Michael Berse, Hennef (DE); Guido Timmer, Essen (DE); Patrik Schiefer, Hennef (DE)

(21) Appl. No.: 15/547,016

(22) PCT Filed: Jan. 29, 2016
(86) PCT No.: PCT/EP2016/051901

§ 371 Date: Jul. 27, 2017

(30) Foreign Application Priority Data
Jan. 30, 2015 (DE) 102015201683.8

(51) Int. Cl. B65G 69/04; B06B 3/00; G10K 15/00

(52) U.S. Cl. CPC B65G 69/04; B65G 2201/042; G10K 15/00; B06B 3/00

(57) ABSTRACT

An apparatus for separating parts during a manufacturing process comprises a sound generating apparatus (19) for generating sound waves and a support (12) constituting a separating surface (14) and mechanically decoupled from the sound generating apparatus, said support being arranged and configured such that the sound waves emitted by the sound generating apparatus (19) move at least a portion of the separating surface (14) such that parts (16) resting thereon are excited such that they move. A corresponding method is also provided.

The present invention relates to a separating apparatus and a method for separating loose parts during a manufacturing process.

The manufacturing process may be an automated manufacturing process, a partly automated manufacturing process or a manufacturing process at a manual workstation. In the case of automated manufacturing processes loose components available as bulk goods must first be separated before they can be individually grasped by a robot and automatically fed to the subsequent manufacturing process. It is common practice to separate loose parts on a support by mechanically setting the support into motion or vibration. This can be performed by mechanically moving the overall support or to push rams against the support from below. The parts resting on the support are thus set in motion, wherein parts lying upon each other are separated and the distance between neighboring parts is increased. With the aid of camera systems and automatic object recognition algorithms it is then possible to recognize individual parts and to transfer their coordinates to the robot arm which grasps the parts.

In the conventional methods large mechanical forces must sometimes be applied to set in motion the plate with the parts to be separated. The mechanical forces and the mechanical force transmission lead to wear of the components involved. Another disadvantage is that conventional separating apparatus are capable of adequately separating only parts of a specific size and/or shape. For parts having a different size and/or shape other separating apparatus are required.

It is an object of the invention to allow for a simplified and improved part separation which is more flexible with respect to size, weight or shape of the parts to be separated.

The apparatus according to the invention is defined by claim 1. The method according to the invention is defined by claim 14.

A supports constitutes the separating surface for parts to be separated. The parts to be separated are placed on the support as bulk goods. The parts may be loose parts, i.e. parts which are not fixedly connected with each other. The parts may also be hooked to each other (for example coil springs). A sound generating apparatus for generating sound waves is provided and is mechanically decoupled from the separating surface and from the support. Thus no direct mechanical connection exists between the sound generating apparatus and the support but at best an indirect mechanical coupling via a frame. Mechanically decoupled is to be understood such that at least a portion of the separating surface is capable of moving relative to the sound generating apparatus. Since no direct mechanical connection is provided between the sound generating apparatus and the separating surface the sound transmission to the support is primarily performed via sound propagation in the free space and not via a direct mechanical connection. It is of importance that between the sound generating apparatus and the support to be moved a sound transmitting medium, for example air or a liquid (water), is arranged which allows for sound transmission in the free space.

The sound transmitting apparatus may be provided with an acoustic diaphragm for generating the sound waves, wherein the acoustic diaphragm is decoupled from the separating surface and from the support. A motion of the acoustic diaphragm is thus not transmitted to the support by mechanical force transmission but rather exclusively by sound waves.

The sound waves are generated by the sound generating apparatus and emitted towards the support so that the sound waves excite the support such that the latter is set in motion which suffices to cause the parts on the support to move or jump. The support is moved by the sound waves in such a way that the parts resting thereon are excited such that they perform a motion that causes the parts to be separated, sorted, oriented in their position and/or disentangled so that the parts can subsequently be grasped and/or inspected.

The sound waves can be emitted continuously or as sound pulses. The length of the sound pulses is preferably variably adjustable. Accordingly, the frequency and/or the amplitude of the sound waves are preferably variably adjustable. Thus it is possible to generate a motion of the support matched to size, shape and/or weight of the parts to be separated. Thus parts of different sizes and/or different weights can be flexibly separated, disentangled and/or placed into a preferred position.

The support can be configured as a flexible disk (film) or as a conveyor belt. In the marginal area the flexible support can be fixedly connected with a frame holding the support. The connection between the surface and the frame may be configured as a releasable connection. For example, the support can be fixedly clamped in its marginal area. It is crucial that the support is set in motion by a sound wave and not by the frame holding the support.

Alternatively, the support may be configured as an essentially rigid plate. Rigid is to be understood such that the flexibility of the plate is lower than that of a flexible disk or film. To prevent a vibration or motion of the support from being transferred to the frame holding the support the plate should not be fixedly connected with the frame but be freely moveable relative to the frame. The frame may be provided with a circumferential flexible rest for the plate, for example. The plate may be held at the frame via a guide which laterally confines the plate in a horizontal direction and allows for a vertical up and down motion of the plate relative to the frame.

The acoustic diaphragm should be arranged below the support, wherein the sound waves are emitted by the acoustic diaphragm with at least one directional component vertically directed from the bottom up towards the support. The sound transmitting path between the acoustic diaphragm and the support should be alterable. The shorter the sound transmitting path, the lager the effect of the sound waves on the support. The longer the sound transmitting path, the smaller the influence of the sound waves on a magnetization of the parts. For this purpose, the sound generating apparatus or the acoustic diaphragm may be configured such that it is adjustable in height, for example at a carriage.

Alternatively, the separating apparatus may be configured as a single system having only one support which is not displaceable. Loading of the support, separating the parts on the support and/or removing the separated parts can be carried out consecutively.

Below the support the frame may comprise a circumferential wall projecting downwards for amplifying the sound waves in the area of the support. The circumferential wall together with the support may constitute a resonating body, for example.

Alternatively, at least two supports may be arranged such that they are adapted to be transported from a separating position above the acoustic diaphragm to an unloading position. The transport of the supports may be carried out such that the supports rotate about a center point on a circular path like a carousel or are arranged on separately displaceable carriages.

According to an exemplary embodiment, a plurality of supports are respectively arranged on a carriage such that they are laterally displaceable. The carriage is configured such that the respective support is displaced from a loading position into a separating position above the acoustic diaphragm. In the loading position the respective carriage is loaded with parts to be separated or separated parts are removed from the respective support. In the separating position the respective support is arranged above the acoustic diaphragm such that the emitted sound waves cause the parts to be separated.

According a particularly preferred exemplary embodiment, two carriages each comprising a support are provided, wherein the carriages are alternately displaced from the separating position into the unloading position. This is to be understood such that a carriage is automatically displaced into the separating position when the other carriage is moved into the unloading position. In combination with an acoustic diaphragm adjustable in height this offers the advantage that the acoustic diaphragm may approach the respective carriage in the separating position and may be removed from the carriage to allow for an exchange of the carriages. This offers the main advantage that at one support the parts can both be loaded and separated on the support, while at the same time at the other support in the unloading position the separated parts can be removed.

Preferably, a blowing apparatus is provided and configured to generate gas pressure surges at least in the marginal area of the support in the separating position to move parts from the wall area of the support towards the center of the separating surface. The center is here understood as the center of gravity of the respective support. Thus contactless separating and sorting of the parts are possible. A mechanical wear of the components involved and the parts to be separated is reduced. Preferably, the blowing apparatus is configured to simultaneously generate gas pressure surges completely around the support which are directed towards the center of the separating surface. The blowing apparatus may further be configured to generate one of a continuous gas or air flow.

Following the separation of the parts the latter may be grasped in a conventional manner by a camera-assisted robot arm and fed to the subsequent manufacturing process.

According to a variant, the support is provided with receiving means for the parts to be separated. During separation of the parts the latter may be moved into the receiving means for being fixed in their position. The shape of the receiving means may be complementary to that of the parts to allow the latter to be securely retained. The receiving means may be arranged at uniform intervals across the separating surface on the support. According to this variant, the parts are separated into a respective receiving means by moving the support. Thus the separation is carried out by moving a respective part into a receiving means by moving the support. Removal of the parts may be carried out without any robotics which first has to sense the position of the parts using an optical camera system, for example. Rather, the positions of the receiving means are known such that removal of the parts from the receiving means can be carried out by simply reaching into each receiving means. Removal of the parts may be carried out from below, i.e. from below the support, for example. The parts are removed from the receiving means from below or fall through the receiving means.

A crucial advantage offered by the invention is that the separating surface is not moved by mechanical force transmission but by sound transmission in a contactless manner and thus the wear of the components involved is reduced. By adjusting the frequency and/or the amplitude of the sound generator the motion of the support can be matched to different component parts. Preferably, a resonant oscillation is generated. The motion of the separating surface caused by sound transmission can be interrupted to allow for the parts to be removed. The support is thus moved by the sound waves for the purpose of separating the parts, while the motion of the support caused by sound transmission can be stopped for the purpose of removing the parts.

Hereunder exemplary embodiments of the invention are described in detail with reference to the figures in which

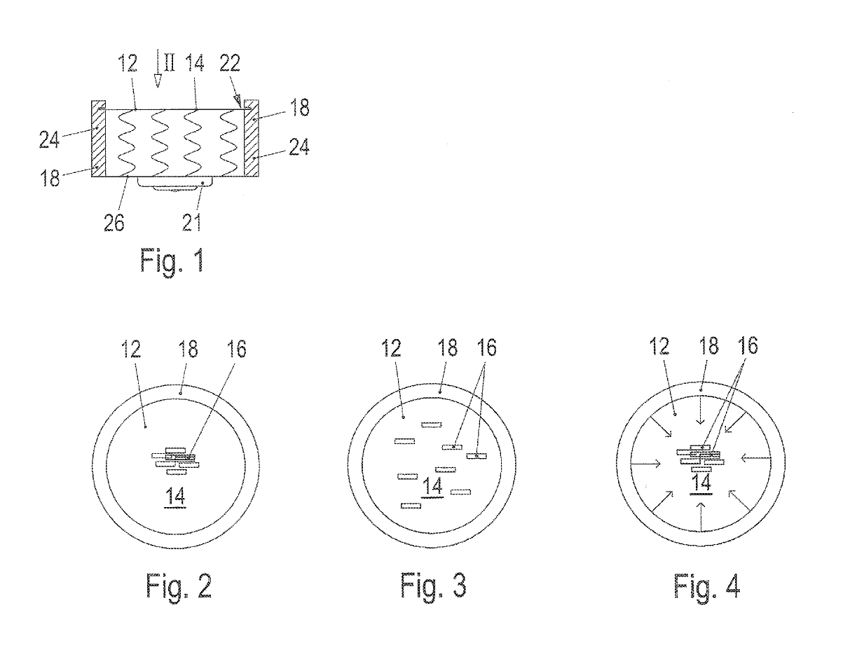

FIG. 1 shows a schematic sectional view of a first exemplary embodiment,

FIG. 2 shows a top view from the direction of arrow II in FIG. 1 in a first working position,

FIG. 3 shows the top view of FIG. 2 in a second working position,

FIG. 4 shows the top view of FIG. 2 in a third working position,

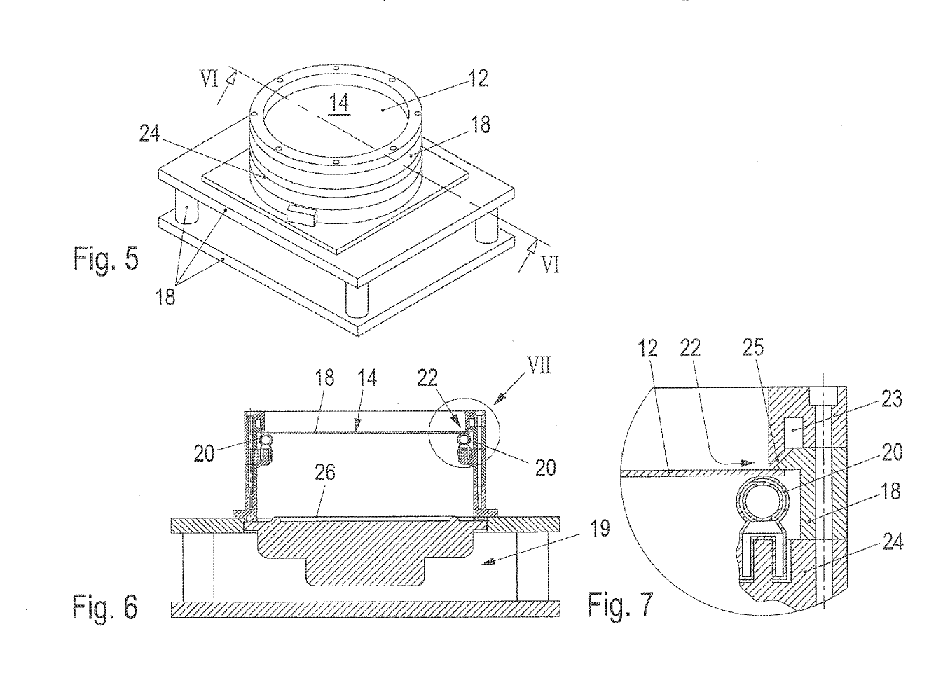

FIG. 5 shows a perspective view of the first exemplary embodiment,

FIG. 6 shows a sectional view along line VI-VI in FIG. 5,

FIG. 7 shows the detail of VII in FIG. 6,

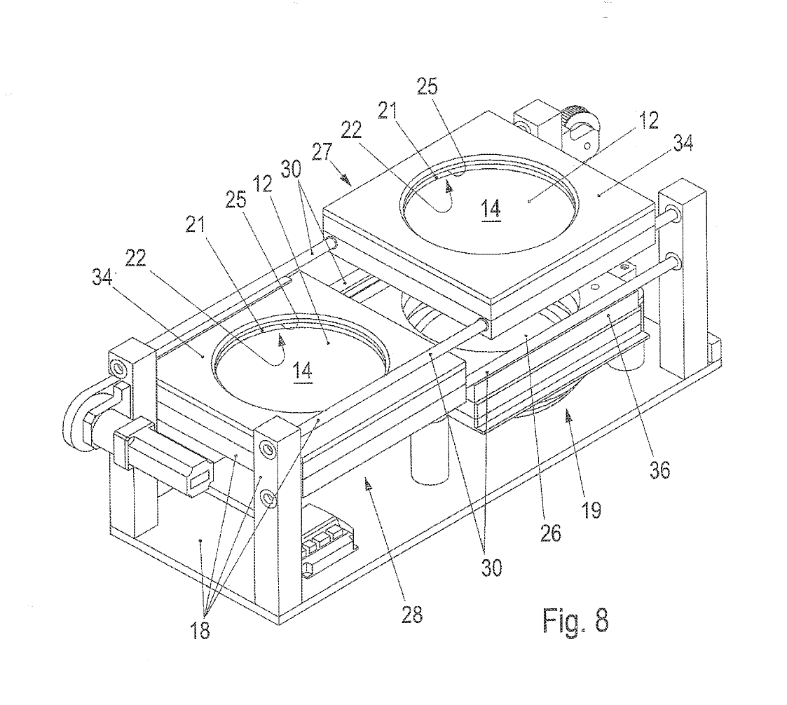

FIG. 8 shows a perspective view of the second exemplary embodiment,

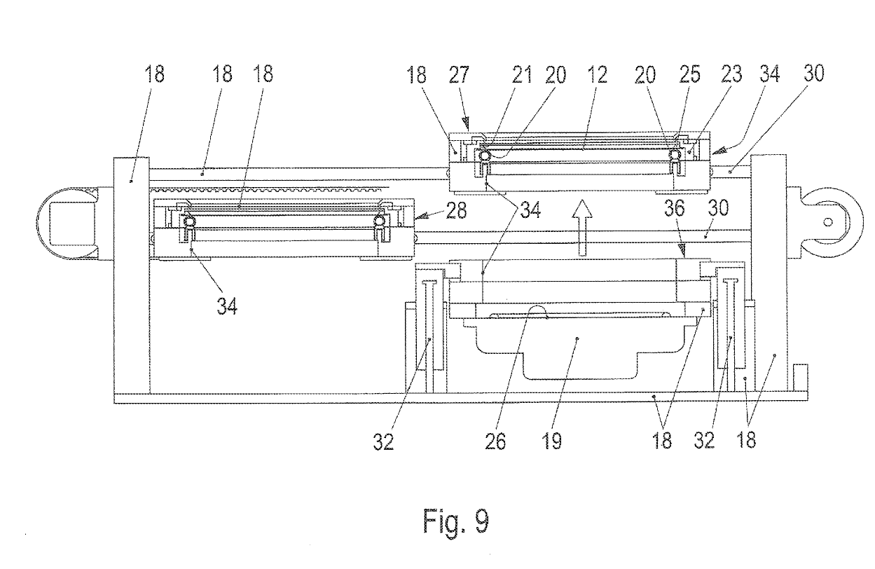

FIG. 9 shows a longitudinal section of the second exemplary embodiment of FIG. 8, and

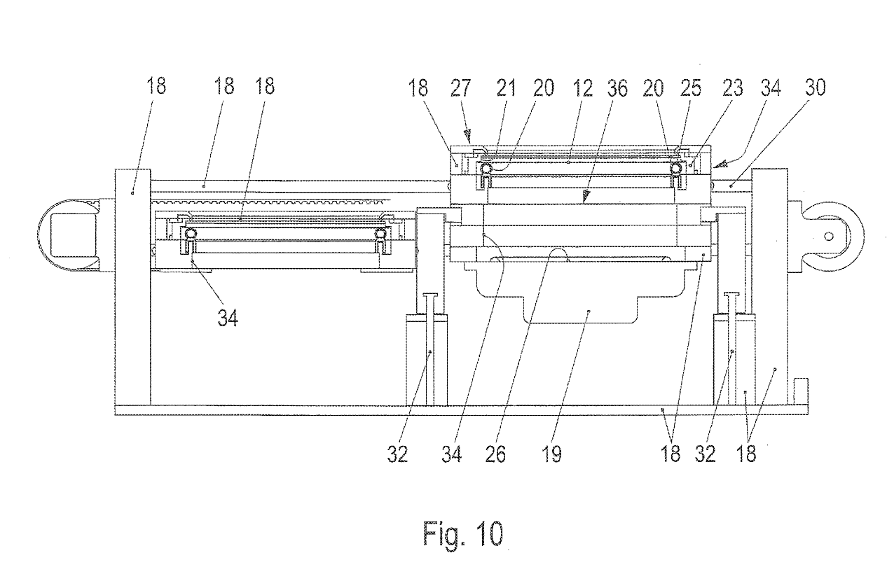

FIG. 10 shows the longitudinal section of FIG. 9 in another working position.

A support 12 constitutes at its upper side the separating surface 14 for the parts 16 to be separated. The parts 16 available as bulk goods are fed to the separating surface 14.

The support 12 is held by a frame 18 without being fixedly connected therewith. Rather, the support 12 is vertically movable relative to the frame 18, wherein the support 12 is laterally confined by the frame 18. A rest 20 made of a flexible rubber material absorbs motions of the support 12 to prevent vibrations of the support 12 from being transmitted to the frame 18. Alternatively, a variant is conceivable where the support 12 is fixedly clamped.

In the exemplary embodiments, the support 12 is configured as a round disk which, in its marginal area, is provided with a circumferential collar 21 which confines the parts 16 to be separated towards the outside.

A blowing apparatus 22 is configured to generate an air flow across the collar 21, which air flow is directed from the outermost marginal area of the support 12 radially inwards towards its center to radially move the parts 16 on the separating surface 14 from the outside inwards. The blowing apparatus 22 is constituted by a blowing air duct 23 completely surrounding the support 12 and an annular gap 25 through which the blowing air flows from the duct 23 to the surface of the support 12.

Below the support 12 the frame 18 is provided with a cylindrical circumferential wall 24 for amplifying the sound waves below the support 12.

The sound waves are generated by an acoustic diaphragm 26 below the support 12. The acoustic diaphragm 26 forms part of a sound generating apparatus 19 in the form of a conventional speaker. By application of an electric voltage the acoustic diaphragm 26 is set in oscillation for the purpose of generating the sound waves. The sound waves propagate towards the support 12 and excite it such that it vibrates, which causes the parts 16 resting thereon to jump.

FIG. 2 shows a top view of the separating apparatus according to the first exemplary embodiment (single system) before the separation of the parts. FIG. 3 shows the same top view after the separation caused by the support 12 having been excited by the sound waves. FIG. 4 shows the same top view after the separation of FIG. 3 and after the parts 16 having been radially moved from the outside inwards towards the center of the support 12 with the aid of the blowing apparatus 22. The first exemplary embodiment is a single system having only one support 12 which is configured such that it is not displaceable relative to the frame 18.

According to the exemplary embodiment of FIGS. 8-10 two supports 12 are provided (double system). Each support 12 is arranged on a carriage 27, 28. The two carriages 27, 28 are respectively horizontally displaceable on rails 30 from an unloading position into a separating and loading position above the acoustic diaphragm 26. The carriages 27, 28 alternately move such that the one carriage automatically reaches the separating position above the acoustic diaphragm 26 when the other carriage 28 reaches the unloading position for unloading the separated parts 16.

The sound generating apparatus 19 with the acoustic diaphragm 26 is configured to be adjustable in height at reciprocating pistons 32 to approach from below the respective carriage 27, 28 in the separating position.

It is conceivable that the acoustic diaphragm 26 generally forms part of a lower housing section 34 which, together with an upper housing section 36 holding the support 12, forms a resonating body. The lower housing section 34 may be adjusted in height from below towards the upper housing section 36 in the direction of the arrow of FIG. 9. FIG. 9 shows the lower housing section 34 and the sound generating apparatus 19 in their lower position. FIG. 10 shows the lower housing section 34 and the sound generating apparatus 19 in their upper position. In this position the walls 24 of the two housing sections 34, 36 together with the support 12 and the acoustic diaphragm 26 form a resonating body.

However, the acoustic diaphragm need not be airtightly connected with the resonant cavity or the support 12. But it is conceivable that the resonant cavity between the acoustic diaphragm 26 and the support 12 is filled with a specific sound transmitting medium. The latter may be air, ionized air, a specific gas, oil or any other sound transmitting medium.

Receiving means of the support 12 not shown in the figures may collect and receive the parts 16 to be separated. The receiving means may be configured as holes or bores in the surface of the support 12. The receiving means should have a shape which is complementary to at least a portion of a part 16.

1. An apparatus for separating parts during a manufacturing process, comprising:
a sound generating apparatus for generating sound waves; and
a support mechanically decoupled from said sound generating apparatus and constituting a separating surface, which is arranged and configured such that the sound waves emitted by said sound generating apparatus move at least a portion of said separating surface so that said parts resting thereon are excited such that they move.

2. The apparatus according to claim 1, wherein the support is held by a frame or clamped therein, wherein the separating surface is movable independently of the frame.

3. The apparatus according to claim 1, wherein the sound generating apparatus is arranged below the support, wherein an acoustic diaphragm of the sound generating apparatus is arranged essentially in parallel to the separating surface.

4. The apparatus according to claim 1, wherein the support is a plate which is movably mounted relative to the frame.

5. The apparatus according to claim 4, wherein the frame comprises a flexible and elastic rest for the plate.

6. The apparatus according to claim 2, wherein the support is a flexible disk or film.

7. The apparatus according to claim 6, wherein a marginal area of the support is connected with the frame.

8. The apparatus according to claim 1, wherein at least in a marginal area of the support a blowing apparatus is arranged such that a gas surge generated by said blowing apparatus moves parts from the marginal area of said support towards the center of the separating surface.

9. The apparatus according to claim 1, wherein at least two supports are arranged such that they are adapted to be transported from a separating position above the acoustic diaphragm into an unloading position.

10. The apparatus according to claim 9, wherein the acoustic membrane is arranged such that it is adjustable in height.

11. The apparatus according to claim 2, wherein below the support the frame is provided with a circumferential wall which amplifies the sound waves.

12. The apparatus according to claim 1, wherein in the area of the separating surface the support is provided with receiving means for the parts.

13. The apparatus according to claim 1, wherein the frequency and/or the amplitude of the generated sound waves are variably adjustable.

14. A method for separating parts during a manufacturing process, wherein said parts rest on a separating surface constituted by a support and a sound generating apparatus for generating sound waves and mechanically decoupled from the support is provided, wherein said parts are moved by a sound wave emitted by said sound generating apparatus exciting at least a portion of said separating surface such that it moves.

15. The method according to claim 14, wherein a plurality of supports are respectively displaced from a separating position above an acoustic diaphragm into an unloading position for removing the separated parts from said support.

16. The method according to claim 15, wherein the acoustic diaphragm is vertically displaced towards the support to improve the sound transmission from said acoustic diaphragm to said support.

17. The method according to claim 14, wherein the parts to be separated are moved by gas pressure surges of a blowing apparatus from a marginal area of the support towards the center of the separating surface.

18. The method according to claim 14, wherein loading and separating of the parts are carried out in a time-shifted manner relative to removing of said parts from the support.

19. The method according to claim 14, wherein the parts are each separated into a receiving means in the support in an area of the separating surface.
